(19) United States
(12) Patent Application Publication
(10) Pub. No.: US 2018/0045979 A1
(43) Pub. Date: Feb. 15, 2018

(54) OPHTHALMIC LENS AND METHOD FOR MAKING THE SAME

(71) Applicant: HON HAI PRECISION INDUSTRY CO., LTD., New Taipei (TW)

(72) Inventor: HSIU-WEN CHIEN, New Taipei (TW)

(21) Appl. No.: 15/278,037

(22) Filed: Sep. 28, 2016

(30) Foreign Application Priority Data
Aug. 11, 2016 (TW) 105125640

(51) Int. Cl. G02C 7/04; G02B 1/04; C09D 5/00; C09D 7/12; C09D 143/02; C09D 171/02

(52) U.S. Cl. CPC G02C 7/049; C09D 143/02; C09D 171/02; C09D 5/00; C09D 7/1216; G02B 1/043; C08K 3/346

(57) ABSTRACT

A method for making an ophthalmic lens includes following steps of providing a suspension liquid and a lens substrate, the suspension liquid comprising a hydrophilic polymer, a clay, and water; and applying the suspension liquid on at least one surface of the lens substrate to cause the clay to be dispersed on the surface of the lens substrate and the hydrophilic polymer to be bonded to the surface of the lens substrate through the clay, thereby forming a hydrophilic layer on the surface of the lens substrate to obtain the ophthalmic lens. The disclosure also provides an ophthalmic lens.

### FIELD

The subject matter herein generally relates to an ophthalmic lens, and method for making the ophthalmic lens.

### BACKGROUND

Contact lenses are commonly worn by users to correct vision, or for cosmetic or therapeutic reasons. Since the contact lens directly contacts eyes of the user when in use, a good hydrophilicity of the contact lens is needed.

### BRIEF DESCRIPTION OF THE DRAWINGS

Implementations of the present technology will now be described, by way of example only, with reference to the attached figures.

FIG. 1 is a flowchart of an exemplary embodiment of a method for making an ophthalmic lens.

FIG. 2 is a cross-sectional view of an exemplary embodiment of an ophthalmic lens.

FIG. 3 is an enlarged cross section of circled portion III of FIG. 2.

FIG. 4 is a cross-sectional view of another exemplary embodiment of an ophthalmic lens.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series and the like.

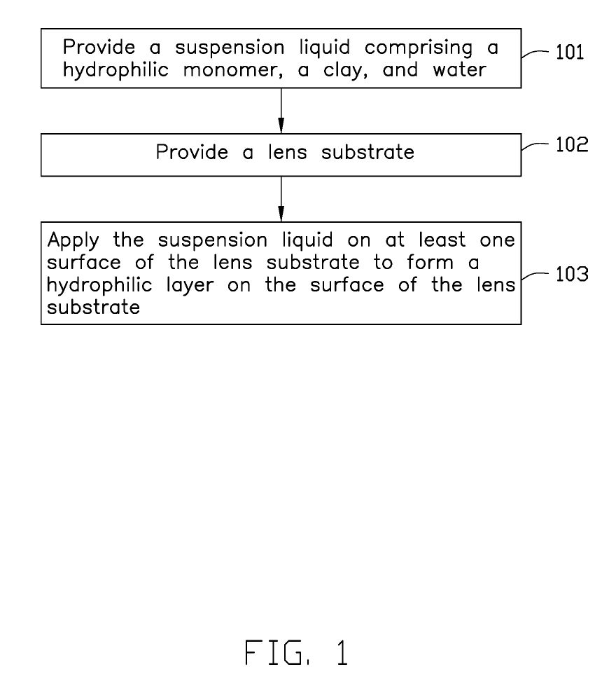

FIG. 1 illustrates a flowchart of a method for making an ophthalmic lens in accordance with an exemplary embodiment. The exemplary method is provided by way of example, as there are a variety of ways to carry out the method. Each block shown in FIG. 1 represents one or more processes, methods, or subroutines, carried out in the exemplary method. Furthermore, the illustrated order of blocks is by example only and the order of the blocks can change. Additional blocks may be added or fewer blocks may be utilized, without departing from this disclosure. The exemplary method can begin at block 101.

At block 101, a suspension liquid comprising a hydrophilic polymer, a clay, and water is provided. The hydrophilic polymer has a mass percentage of about 0.1% to about 65% of a total mass of the suspension liquid. The clay has a mass percentage of about 0.01% to about 42% of the total mass of the suspension liquid. The water has a mass percentage of about 25% to about 90% of the total mass of the suspension liquid.

The hydrophilic polymer may be selected from a group consisting of poly(ethylene glycol) (PEG), poly(vinyl alcohol) (PVA), polyvinyl pyrrolidone (PVP), polyphosphorylcholine glycol acrylate, poly-N-vinyl-2-piperidone, poly-N-vinyl-2-caprolactam, poly-N-vinyl-3-methyl-2-caprolactam, poly-N-vinyl-3-methyl-2-piperidone, poly-N-vinyl-4-methyl-2-piperidone, poly-N-vinyl-4-methyl-2- caprolactam, poly-N-vinyl-3-vinyl-2-pyrrolidone, poly-N-vinyl-4,5-dimethyl-2-pyrrolidone, polyvinylimidazole, poly-N,N-dimethylacrylamide, polyacrylamide, polyhydroxypropyl(meth)acrylate, polyhydroxypropyl(meth)acrylamide, and polyethylene oxide.

In at least one exemplary embodiment, the clay comprises aluminium silicate as a main composition. The clay may be selected from a group consisting of kaolinite, dickite, halloysite, nacrite, montmorillonite, pyrophyillite, talc, vermiculite, nontronite, and saponite, illite, chlorite, sepiolite, zeolite, attapulgite, and synthetic clay (such as laponite). The clay is lamellar. The clay has a length of about 1 nm to about 1000 nm, and has a thickness of about 0.1 nm to about 100 nm. In at least one exemplary embodiment, the clay is a lamellar montmorillonite. The lamellar montmorillonite has length of about 23 nm to about 27 nm, and has a thickness of about 1 nm.

At block 102, a lens substrate is provided. The lens substrate may be made of hydrogel or silicone hydrogel.

At block 103, at least one surface of the lens substrate is in contact with the suspension liquid by coating or spraying the suspension liquid onto the surface of the lens substrate, or by immersing the lens substrate in the suspension liquid, to cause the lens substrate and the suspension liquid to react. As such, the clay is dispersed on the surface of the lens substrate, and the hydrophilic polymer is bonded to the surface of the lens substrate by the clay, so that a hydrophilic layer is formed on the surface of the lens substrate to obtain an ophthalmic lens. The clay is bonded to the surface of the lens substrate and the hydrophilic polymer by at least one of hydrogen bonding and siloxane bonding.

In the illustrated exemplary embodiment, the lens substrate is immersed in the suspension liquid and the suspension liquid is stirred, to cause the lens substrate and the suspension liquid to react which forms the hydrophilic layer on the surface of the lens substrate to obtain the ophthalmic lens. Then, the ophthalmic lens is taken out from the suspension liquid. In at least one exemplary embodiment, the lens substrate and the suspension liquid react at a temperature of between room temperature and about 100 degrees Celsius.

A thickness of the hydrophilic layer can be adjusted by controlling a time of the reaction of the lens substrate and the suspension liquid. That is, if a hydrophilic layer having a greater thickness is needed, a time of the lens substrate being in contact with the suspension liquid can be increased. In at least one exemplary embodiment, the hydrophilic layer has a thickness of about 1 nm to about 10 μm, to cause the ophthalmic lens to have a good hydrophilicity and a good oxygen permeability.

### EXAMPLE 1

A suspension liquid was formed by mixing poly(ethylene glycol), laponite, and water. The poly(ethylene glycol) had a mass percentage of 23% of a total mass of the suspension liquid. The laponite had a mass percentage of 5% of the total mass of the suspension liquid. The water had a mass percentage of 72% of the total mass of the suspension liquid. A lens substrate was provided, and was immersed in the suspension liquid for 1 hour at 75 degrees Celsius to form an ophthalmic lens. Then, the ophthalmic lens was taken out from the suspension liquid.

### EXAMPLE 2

A suspension liquid was formed by mixing poly(ethylene glycol), laponite, and water. The poly(ethylene glycol) had a mass percentage of 25% of a total mass of the suspension liquid. The laponite had a mass percentage of 3% of a total mass of the suspension liquid. The water had a mass percentage of 72% of a total mass of the suspension liquid. A lens substrate was provided, and was immersed in the suspension liquid for 1.5 hours at 80 degrees Celsius to form an ophthalmic lens. Then the ophthalmic lens was taken out from the suspension liquid.

### EXAMPLE 3

A suspension liquid was formed by mixing poly(ethylene glycol), laponite, and water. The poly(ethylene glycol) had a mass percentage of 33% of a total mass of the suspension liquid. The laponite had a mass percentage of 2% of a total mass of the suspension liquid. The water had a mass percentage of 65% of a total mass of the suspension liquid. A lens substrate was provided, and was immersed in the suspension liquid for 1.5 hours at 95 degrees Celsius to form an ophthalmic lens. Then the ophthalmic lens was taken out from the suspension liquid.

### EXAMPLE 4

A suspension liquid was formed by mixing polyphosphorylcholine glycol acrylate, laponite, and water. The polyphosphorylcholine glycol acrylate had a mass percentage of 30% of a total mass of the suspension liquid. The laponite had a mass percentage of 2.5% of a total mass of the suspension liquid. The water had a mass percentage of 67.5% of a total mass of the suspension liquid. A lens substrate was provided, and was immersed in the suspension liquid for 2 hours at 90 degrees Celsius to form an ophthalmic lens. Then the ophthalmic lens was taken out from the suspension liquid.

### EXAMPLE 5

A suspension liquid was formed by mixing polyphosphorylcholine glycol acrylate, laponite, and water. The polyphosphorylcholine glycol acrylate had a mass percentage of 15% of a total mass of the suspension liquid. The laponite had a mass percentage of 1% of a total mass of the suspension liquid. The water had a mass percentage of 84% of a total mass of the suspension liquid. A lens substrate was provided, and was immersed in the suspension liquid for 2 hours at 90 degrees Celsius to form an ophthalmic lens. Then the ophthalmic lens was taken out from the suspension liquid.

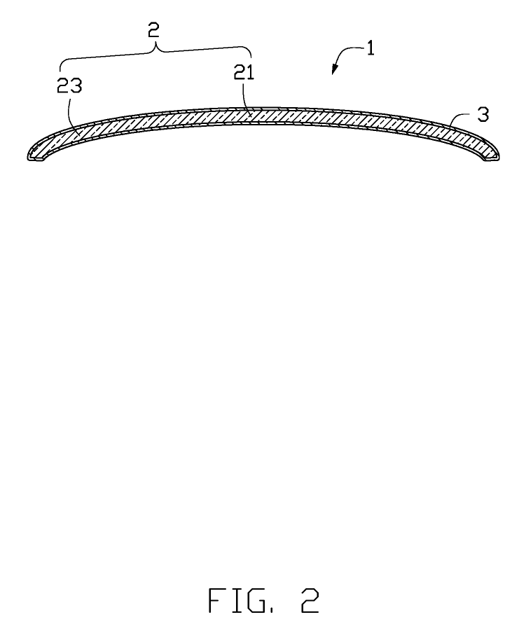

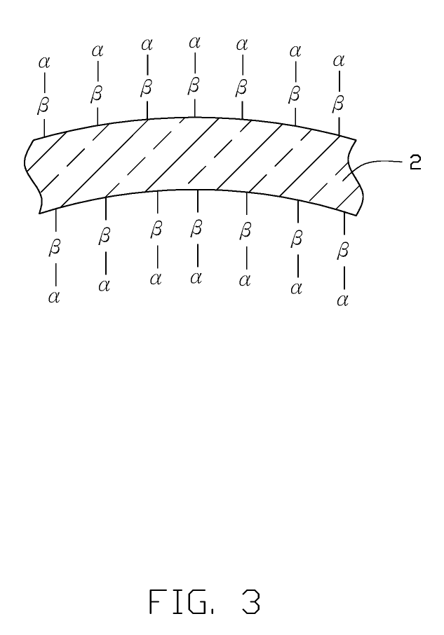

FIGS. 2 and 3 illustrate an exemplary embodiment of an ophthalmic lens 1 made by the above method. The ophthalmic lens 1 comprises a lens substrate 2 and a hydrophilic layer 3 formed on at least one surface of lens substrate 2. The hydrophilic layer 3 comprises hydrophilic polymer α and clay β. The hydrophilic polymer a is bonded to the surface of the lens substrate 2 by the clay β. The lens substrate 2 may be made of hydrogel or silicone hydrogel. The lens substrate 2 comprises a transparent pupil region 21 and a substantially annular iris region 23 surrounding the pupil region 21. In the illustrated exemplary embodiment, the hydrophilic layer 3 is formed on the whole surface of the lens substrate 2.

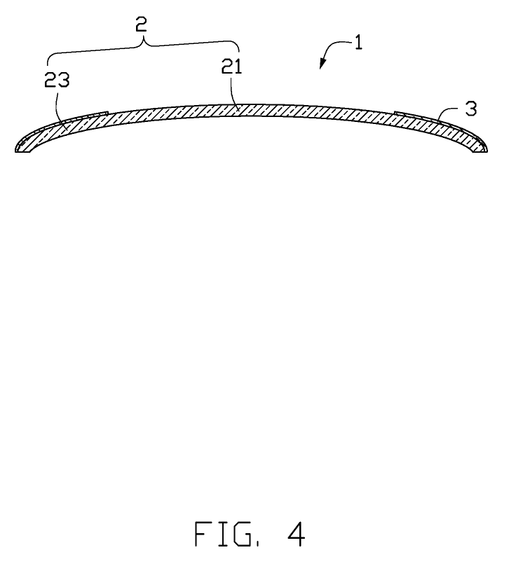

FIGS. 4 illustrates that another exemplary embodiment of an ophthalmic lens 1, the hydrophilic layer 3 is only formed on a portion of the surface of lens substrate 2, such as the portion corresponding to the iris region 23.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

1. A method for making an ophthalmic lens comprising:
providing a suspension liquid and a lens substrate, the suspension liquid comprising a hydrophilic polymer, a clay, and water; and
applying the suspension liquid on at least one surface of the lens substrate to cause the clay to be dispersed on the surface of the lens substrate and the hydrophilic polymer to be bonded to the surface of the lens substrate through the clay, thereby forming a hydrophilic layer on the surface of the lens substrate to obtain the ophthalmic lens; and
wherein the hydrophilic polymer has a mass percentage of about 0.1% to about 33% of a total mass of the suspension liquid, the clay has a mass percentage of about 0.01% to about 42% of the total mass of the suspension liquid, the water has a mass percentage of about 25% to about 90% of the total mass of the suspension liquid, each clay has a length of about 1 nm to about 1000 nm, and has a thickness of about 0.1 nm to about 100 nm.

2. (canceled)

3. The method of claim 1, wherein the clay comprises aluminium silicate.

4. The method of claim 3, wherein the clay is selected from a group consisting of kaolinite, dickite, halloysite, nacrite, montmorillonite, pyrophyillite, vermiculite, nontronite, saponite, illite, chlorite, zeolite, attapulgite, and synthetic clay.

5. The method of claim 1, wherein the hydrophilic polymer is selected from a group consisting of poly(ethylene glycol), poly(vinyl alcohol), polyvinyl pyrrolidone, polyphosphorylcholine glycol acrylate, poly-N-vinyl-2-piperidone, poly-N-vinyl-2-caprolactam, poly-N-vinyl-3-methyl-2-caprolactam, poly-N-vinyl-3-methyl-2-piperidone, poly-N-vinyl-4-methyl-2-piperidone, poly-N-vinyl-4-methyl-2-caprolactam, poly-N-vinyl-3-vinyl-2-pyrrolidone, poly-N-vinyl-4,5-dimethyl-2-pyrrolidone, polyvinylimidazole, poly-N,N-dimethylacrylamide, polyacrylamide, polyhydroxypropyl(meth)acrylate, polyhydroxypropyl(meth)acrylamide, and polyethylene oxide.

6. The method of claim 1, wherein the lens substrate and the suspension liquid is reacted at a temperature of about room temperature to about 100 degrees centigrade.

7. The method of claim 1, wherein the clay is bonded to the surface of the lens substrate and the hydrophilic polymer by at least one of hydrogen bonding and siloxane bonding.

8. The method of claim 1, wherein the hydrophilic layer has a thickness of about 1 nm to about 10 μm.

9-12. (canceled)
